(19) United States
(12) Patent Application Publication
(10) Pub. No.: US 2008/0192237 A1
(43) Pub. Date: Aug. 14, 2008

(54) Photoelectric transducer capable of detecting a finger resting on it, and display panel having the same

(75) Inventor: Takumi Yamamoto, Hino-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/012,978

(22) Filed: Feb. 6, 2008

(30) Foreign Application Priority Data
Feb. 8, 2007 (JP) 2007-029311

(51) Int. Cl. G01N 21/00

(52) U.S. Cl. 356/73

(57) ABSTRACT

A photoelectric transducer includes a photoelectric transducer element array which is composed of a plurality of photoelectric transducer elements, a lower polarizing plate which allows passage of only light polarized in a specific polarized direction, and an upper polarizing plate which allows passage of only light polarized in a specific polarized direction. The photoelectric transducer further includes liquid crystals which are arranged between the photoelectric transducer element array and the upper polarizing plate and which guide the light that has passed through the lower polarizing plate, respectively through the upper polarizing plate in a transmitted state and not through upper polarizing plate in a non-transmitted state. The light that has passed through the upper polarizing plate is reflected by an object resting on the upper polarizing plate, it is thereby determined whether an object exists.

### CROSS-REFERENCE TO RELATED APPLICATIONS

This application is based upon and claims the benefit of priority from prior Japanese Patent Application No. 2007-029311, filed Feb. 8, 2007, the entire contents of which are incorporated herein by reference.

### BACKGROUND OF THE INVENTION

1. Field of the Invention

The present invention relates to a photoelectric transducer. More particularly, the invention relates to a photoelectric transducer that can detect an object, such as a finger, resting on it and also to a display panel that has the photoelectric transducer.

2. Description of the Related Art

A device is known, which includes photoelectric transducer elements provided on an insulating substrate, particularly on a transparent substrate. Jpn. Pat. Appln. KOKAI Publication No. 6-236980 discloses a device comprising a plurality of thin-film-transistor (hereinafter referred to as TFT) photoelectric transducer elements (hereinafter referred to as TFT photoelectric transducer elements) which are arranged, one adjacent to another, and each of which has a photoelectric transducer part made of amorphous silicon (hereinafter referred to as a-Si).

FIG. 11 is the photoelectric characteristic of an a-Si TFT photoelectric transducer element of the ordinary type. This characteristic has been determined by measuring the drain-source current Ids [A], using the luminance of illumination light as parameter under conditions such that channel width/length (W/L)=180000/9 μm, source voltage Vs=0V and drain voltage Vd=10V.

As seen from FIG. 11, the drain-source current Ids increases as the luminance of the illumination light increases. In particular, when the luminance of the illumination light increases, the drain source current Ids prominently increases in a reverse bias region where the gate-source voltage has a negative value (Vgs<0). Usually, the characteristic observed in this reverse bias region is utilized so that the a-Si TFT photoelectric transducer element may be used as a photoelectric transducer element that detects the luminance of the illumination light as a change in the drain-source current Ids.

FIG. 12 is a sectional view showing a structure that a photoelectric transducer having such TFT photoelectric transducer elements may have.

Each TFT photoelectric transducer element 11 includes a gate electrode 12, transparent insulating films 13 and 14, a photoelectric transducer part 16, a source electrode 18, and a drain electrode 19. The gate electrode 12 is formed on a transparent TFT substrate 10. The transparent insulating film 13 is formed on the gate electrode 12. The photoelectric transducer part 16 is made of a-Si, formed on the insulating film 13 and opposed to the gate electrode 12. The source electrode 18 and drain electrode 19 are formed on the photoelectric transducer part 16. The transparent insulating film 14 covers the upper surface of the TFT photoelectric transducer elements 11. A gap 27 is provided on the transparent insulating film 14 by a seal member or a gap member, and thus a transparent countersubstrate 20 is spaced apart by a prescribed distance from the transparent insulating film 14. A photoelectric transducer is thus fabricated.

The prescribed distance is determined from the space between any adjacent TFT photoelectric transducer elements 11 and the refractive indices of the other components of the photoelectric transducer. That is, the prescribed distance is determined so that the light 24 applied from a backlight 22 arranged at the back of the TFT substrate 10 to the countersubstrate 20 through the space between the adjacent TFT photoelectric transducer elements 11 may be reflected by an object, such as a finger 26 resting on the countersubstrate 20 and the reflected light 28 can then be reliably converted to an electrical signal by the photoelectric transducer part 16 made of a-Si.

In this photoelectric transducer, the photoelectric transducer part 16 converts the light 28 reflected by the finger 26 (more precisely, the grooves defining the fingerprint, which are not shown) to an electrical signal. The fingerprint is recognized from this electrical signal.

With the conventional photoelectric transducer described above, however, the reflected light 28 cannot be distinguished from the light applied extraneously (particularly, sunlight) that has luminance equal to or higher than that of the reflected light 28. If the finger 26 does not rest on the countersubstrate 20, the extraneous light is applied to the photoelectric transducer part 16 of the TFT photoelectric transducer element 11, exactly in the same way as the reflected light 28 (i.e., light 24 reflected by the finger 26). Inevitably, the reflected light 28, i.e., signal light, cannot be distinguished from the extraneous light such as sunlight. In view of this, the conventional photoelectric transducer cannot be used in an apparatus, such as a touch panel, which generates control signal upon detecting object (e.g., finger) resting on it.

### BRIEF SUMMARY OF THE INVENTION

The present invention has been made in consideration of the foregoing. An object of the invention is to provide a photoelectric transducer that can detect an object, if any, resting on it even if the extraneous light applied to it has luminance equal to or higher than the light emitted from the backlight. Another object of this invention is to provide a display panel that has such a photoelectric transducer.

A photoelectric transducer according to the present invention comprises a photoelectric transducer element array which is composed of a plurality of photoelectric transducer elements including a first photoelectric transducer element and a second photoelectric transducer element, a lower polarizing plate which is arranged on a lower surface of the photoelectric transducer element array and allows passage of only light polarized in a first specific polarized direction, and an upper polarizing plate which is arranged above an upper surface of the photoelectric transducer element array and allows passage of only light polarized in a second specific polarized direction different from the first specific polarized direction. The photoelectric transducer further comprises liquid crystals which are arranged between the photoelectric transducer element array and the upper polarizing plate and which guide the light that has passed through the lower polarizing plate, respectively through the upper polarizing plate in a transmitted state and not through upper polarizing plate in a non-transmitted state. In the photoelectric transducer thus configured, the light that has passed through the upper polarizing plate is reflected by an object resting on the upper polarizing plate, it is thereby determined whether an object exists.

A display panel according to the present invention has a display region and a touch-sensor region and comprises a TFT substrate including pixel electrodes provided within the display region (128) and within the touch-sensor region (122), a backlight which is provided at the back of the TFT substrate, a countersubstrate which is arranged at a surface of the TFT substrate and spaced apart therefrom, liquid crystals which are provided between the TFT substrate and the countersubstrate, a lower polarizing plate which is arranged on a lower surface of the TFT substrate and which allows passage of only light polarized in a first specific polarized direction, and an upper polarizing plate which is arranged on an upper surface of the countersubstrate and which allows passage of only light polarized in a second specific polarized direction different from the first specific polarized direction. Switching elements are connected to the pixel electrodes provided within the display region of the TFT substrate. A first photoelectric transducer element and a second photoelectric transducer element are connected to the pixel electrodes provided within the touch-sensor region of the TFT substrate. The display panel further includes detecting liquid-crystal controlling means which controls the liquid crystal associated with the first photoelectric transducer element, causing the same to guide the light that has passed the lower polarizing plate, through the upper polarizing plate in a transmitted state, and which controls the liquid crystal associated with the second photoelectric transducer element, causing the same to guide the light that has passed the lower polarizing plate, not through the upper polarizing plate in a non-transmitted state, and display liquid-crystal driving means which drives the switching elements provided in the display region, causing the display region to display an image.

In the present invention, only the first photoelectric transducer element performs photoelectric conversion of signal light, such as the light reflected by an object, and the first and second photoelectric transducer elements performs photoelectric conversion of the extraneous light, such as sunlight. Therefore, the photoelectric transducer element array can generate an output that corresponds to the type of input light. Hence, the present invention can provide a photoelectric transducer and a display panel, which can distinguish signal light, such as reflected light, from extraneous light, such as sunlight.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A is a magnified sectional view showing the configuration of a photoelectric transducer according to a first embodiment of the present invention;

FIG. 1B is a sectional view explaining how light travels in the photoelectric transducer of FIG. 1A if a finger rests on the upper polarizing plate of the photoelectric transducer;

FIG. 1C is a sectional view explaining how intense extraneous light travels in the photoelectric transducer of FIG. 1A;

FIG. 2 is a table showing the various operating modes of the photoelectric transducer according to the first embodiment;

FIG. 3 is a circuit diagram of the detection circuit that determines whether sensor TFTs have converted light to an electrical signal;

FIG. 4 is a plan view of a display panel that incorporates a plurality of photoelectric transducers according to the first embodiment of this invention;

FIG. 5 is a magnified sectional view showing the configuration of a photoelectric transducer according to a second embodiment of the present invention;

FIG. 6 is a magnified sectional view showing the configuration of a photoelectric transducer according to a third embodiment of the present invention;

FIG. 7A is a sectional view explaining how light travels in the photoelectric transducer of FIG. 6 if a finger rests on the upper polarizing plate;

FIG. 7B is a sectional view explaining how intense extraneous light travels in the photoelectric transducer of FIG. 6;

FIG. 8 is a magnified sectional view showing the configuration of a photoelectric transducer according to a fourth embodiment of the present invention;

FIG. 9A is a magnified sectional view of a display panel according to a fifth embodiment of the present invention, in which the display section and the touch-panel section are integrally formed;

FIG. 9B is a magnified sectional view of a display panel according to a sixth embodiment of the present invention, in which the display section and the touch-panel section are integrally formed;

FIG. 10 is a diagram showing the circuit configuration including one touch sensor;

FIG. 11 is a graph representing the photoelectric characteristic of a conventional TFT photoelectric transducer; and

FIG. 12 is a magnified sectional view showing the configuration of the conventional TFT photoelectric transducer.

### DETAILED DESCRIPTION OF THE INVENTION

The best mode for carrying out the present invention will be described, with reference to the accompanying drawings.

### First Embodiment

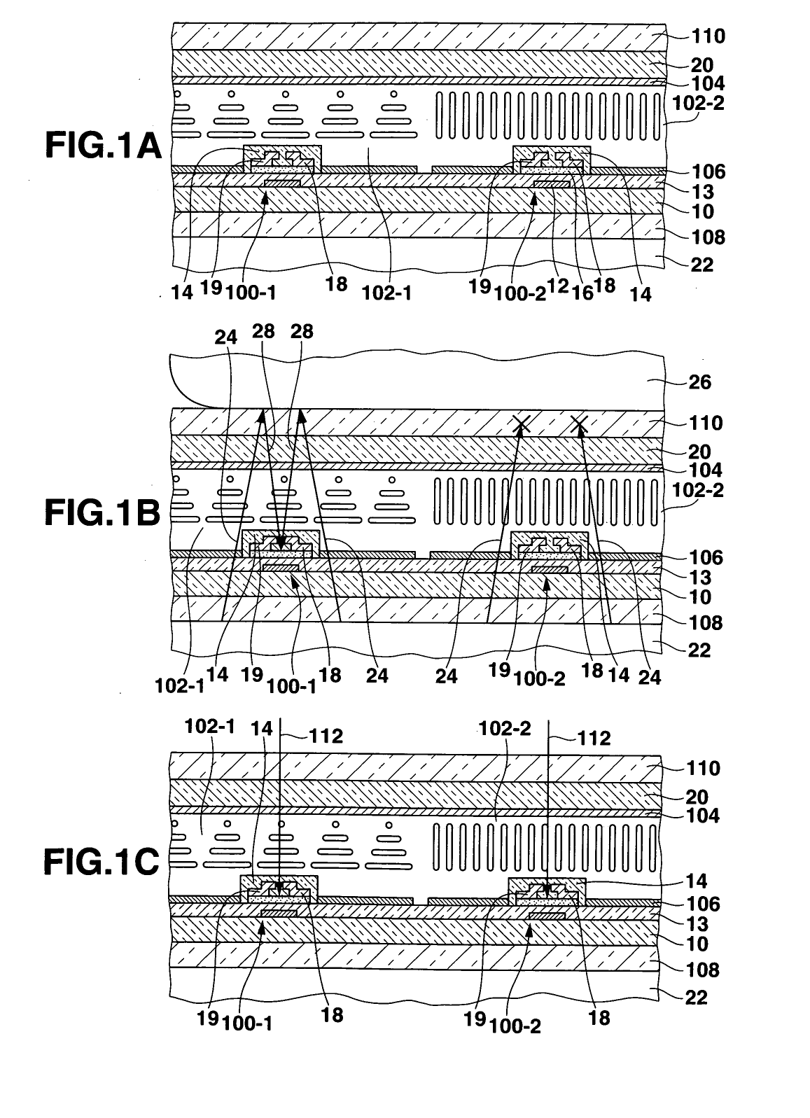

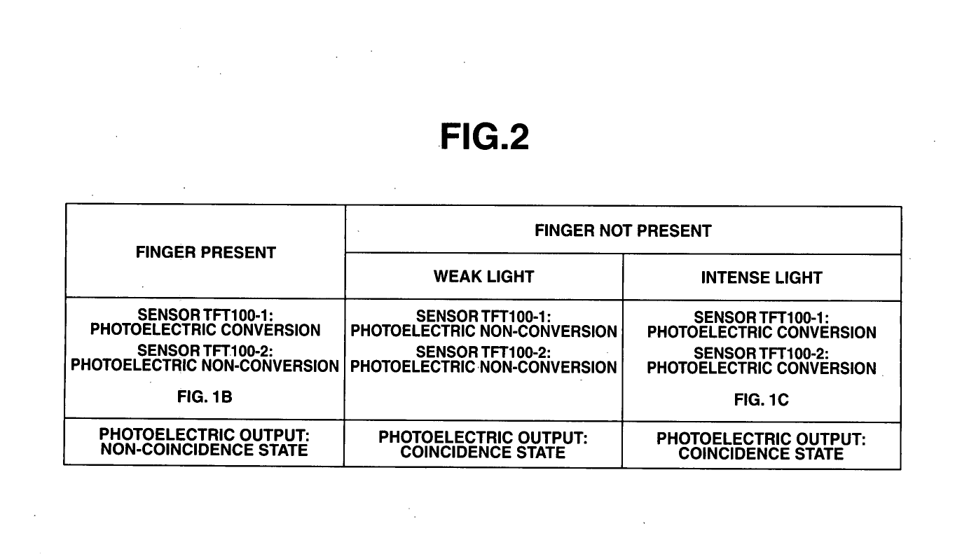

FIG. 1A is a magnified sectional view showing the configuration of a photoelectric transducer according to the first embodiment of the present invention. For simplicity of illustration, only two of the TFT photoelectric transducer elements of this embodiment, i.e., a first sensor TFT 100-1 and a second sensor TFT 100-2 are shown in FIG. 1A. In FIG. 1A, the components identical to those of the conventional TFT photoelectric transducer shown in FIG. 12 are designated by the same reference numbers.

The sensor TFTs 100-1 and 100-2 each includes a gate electrode 12, transparent insulating films 13 and 14, a photoelectric transducer part 16, a source electrode 18, and a drain electrode 19. The gate electrode 12 is formed on a transparent TFT substrate 10. The transparent insulating film 13 is formed on the gate electrode 12. The photoelectric transducer part 16 is made of a-Si, formed on the insulating film 13 and opposed to the gate electrode 12. The source electrode 18 and drain electrode 19 are formed on the photoelectric transducer part 16. The transparent insulating film 14 covers the upper surface and sides of each of the sensor TFTs 100-1 and 100-2. A transparent countersubstrate 20 is spaced apart by a prescribed distance from the transparent insulating film 14 by a seal member or a gap member (not shown) and is provided above the transparent insulating film 14. The photoelectric transducer shown in FIG. 1A is thus fabricated.

In the photoelectric transducer according to this embodiment, TN liquid crystals 102-1 and 102-2 are filled in the regions spaced by the prescribed distance. To drive the TN liquid crystals 102-1 and 102-2, a transparent common electrode 104 having a uniform thickness is formed on the entire lower surface of the countersubstrate 20, and transparent pixel electrodes 106 are formed on the insulating film 13. The first liquid crystal 102-1 provided on the first sensor TFT 100-1 (photoelectric transducer element) is orientated to rotate the light beam passing through the first liquid crystal 102-1 through 90°, by virtue of the voltage between the common electrode 104 and the pixel electrode 106. On the other hand, the second liquid crystal 102-2 provided on the second sensor TFT 100-2 (photoelectric transducer element) is orientated not to rotate the light beam passing through the second liquid crystal 102-2, by virtue of the voltage between the common electrode 104 and the pixel electrode 106. In FIG. 1A, the two alignment layers provided on the lower surface of the common electrode 104 and the upper surface of the pixel electrode 106, respectively, are not shown for simplicity of illustration. In the liquid crystal panel, in which the liquid crystals 102-1 and 102-2 are subjected to active driving, a switching TFT (not shown) is connected to each pixel electrode 106 and supplies to the pixel electrode a voltage that corresponds to the image signal supplied to the drain of the switching TFT.

On the lower surface of the transparent TFT substrate 10, a lower polarizing plate 108 is provided. On the lower surface of the lower polarizing plate 108, a backlight 22 is arranged. The backlight 22 emits white light, red light or infrared ray. On the upper surface of the transparent countersubstrate 20, an upper polarizing plate 110 is formed. The lower polarizing plate 108 and the upper polarizing plate 110 are arranged, with their polarization axes (transmission axes) intersecting at right angles.

The prescribed distance mentioned above is determined from the gap between the sensor TFTs 100-1 and 100-2 and the refractive indices of the other components of the photoelectric transducer. That is, the prescribed distance is so long that the photoelectric transducer parts 16 of the sensor TFTs 100-1 and 100-2 may perform accurate photoelectric conversion of the light which is first applied from the backlight 22 arranged on the lower surface of the TFT substrate 10, which then travels through the gap between the adjacent sensor TFTs 100-1 and 100-2 to the countersubstrate 20 and which is finally reflected by an object, such as a finger, resting on the upper polarizing plate 110.

How the photoelectric transducer so configured as described above operates will be explained with reference to FIG. 1B, FIG. 1C and FIG. 2. FIG. 1B is a sectional view explaining how light travels if a finger 26 rests on the upper polarizing plate 110. FIG. 1C is a sectional view explaining how intense extraneous light 112 travels in the photoelectric transducer. FIG. 2 is a table showing the various operating modes of the photoelectric transducer.

In this embodiment, as shown in FIG. 1B, the lower polarizing plate 108 formed on the lower surface of the transparent TFT substrate 10 linearly polarizes, in a specific direction, the light 24 emitted from the backlight 22. The light 24 thus polarized travels through the gap between the adjacent sensor TFTs 100-1 and 100-2, passes through the TFT substrate 10, insulating film 13 and pixel electrodes 106, and is applied to the liquid crystals 102-1 and 102-2 arranged on the sensors TFTs 100-1 and 100-2, respectively.

The light 24 emitted from the backlight 22 and applied to the first liquid crystal 102-1 arranged on the first sensor TFTs 100-1 is rotated through 90° because of the molecular orientation of the first liquid crystal 102-1. The light 24 rotated through 90° passes through the common electrode 104 and the countersubstrate 20 and is applied to the upper polarizing plate 110.

On the other hand, the light 24 applied to the second liquid crystal 102-2 arranged on the second sensor TFTs 100-2 is not rotated at all because of the molecular orientation of the second liquid crystal 102-2. The light 24 still traveling in the direction, to which it has been polarized by the lower polarizing plate 108, passes through the common electrode 104 and countersubstrate 20 and is applied to the upper polarizing plate 110.

As mentioned above, the upper polarizing plate 110 is arranged, with its polarization axis intersecting at right angles with that of the lower polarizing plate 108. Therefore, the light 24 rotated by 90° as it passes through the first liquid crystal 102-1 provided on the first sensor TFT 100-1 can travel through the upper polarizing plate 110. However, the light 24 not having passed through the second liquid crystal 102-2 provided on the second sensor TFT 100-2 and therefore not rotated at all cannot pass through the upper polarizing plate 110 and is eventually absorbed by the upper polarizing plate 110. As a result, the light 24 emitted from the backlight 22 emerges from only the region of the upper polarizing plate 110 corresponding to the first sensor TFT 104.

The light 24 thus emerging is reflected by the finger 26, i.e., object, resting on the upper polarizing plate 110. (More precisely, the light 24 is reflected by the grooves defining the fingerprint formed on that part of the countersubstrate 20 which the finger 26 touches. The grooves are not shown in FIG. 1B.) The light thus reflected (hereinafter called reflected light 28) enters the photoelectric transducer. The reflected light 28 travels through the upper polarizing plate 110, countersubstrate 20, common electrode 104, liquid crystal 102-1 and insulating film 14. The reflected light 28 is eventually applied to the photoelectric transducer part 16 of the first sensor TFT 100-1.

As long as the finger rests on the photoelectric transducer, the first sensor TFT 100-1 performs photoelectric conversion, while the second sensor TFT 100-2 does not perform photoelectric conversion as shown in column “Finger present” in the table shown in FIG. 2. This state (that is, the sensor TFTs 100-1 and 100-2 remain in a photoelectric conversion state and a photoelectric non-conversion state, respectively) shall be called non-coincidence state of photoelectric-output (i.e., object-presence state).

Assume that as shown in FIG. 1C, the finger 26 does not touch the upper polarizing plate 110 and extraneous light 112 having higher luminance than the light 24 emitted by the backlight 22, such as sunlight, is applied to the photoelectric transducer. Then, the extraneous light 112 passes through the upper polarizing plate 110, is linearly polarized in a specific direction, travels through the countersubstrate 20 and common electrode 104 and is applied to the liquid crystals 102-1 and 102-2. In the first liquid crystal 102-1 arranged on the first sensor TFT 100-1, the extraneous light 112 is rotated by 90° because of the molecular orientation of the first liquid crystal 102-1. The light 122 thus rotated travels through the insulating film 14 and is applied to the first sensor TFT 100-1. The extraneous light 112 applied to the second liquid crystal 102-2 arranged on the second sensor TFT 100-2 is not rotated because of the molecular orientation of the second liquid crystal 102-2, travels through the insulating film 14 and is applied to the second sensor TFT 100-2. In this case, the direction of the polarization axis of the upper polarizing plate 110 achieves no effects at all.

That is, both sensor TFTs 100-1 and 100-2 perform photoelectric conversion as shown in column “Intense light” of “Finger not present” in the table shown in FIG. 2. In the present embodiment, this state is defined as coincidence state of photometric-output (i.e., object-absence state).

If the luminance of the extraneous light 112 is low, neither sensor TFT 100-1 nor sensor TFT 100-2 performs photoelectric conversion as shown in column “Weak light” of “Finger not present” in the table shown in FIG. 2. This state is defined also as coincidence state of photoelectric-output (i.e., object-absence state) in the present embodiment.

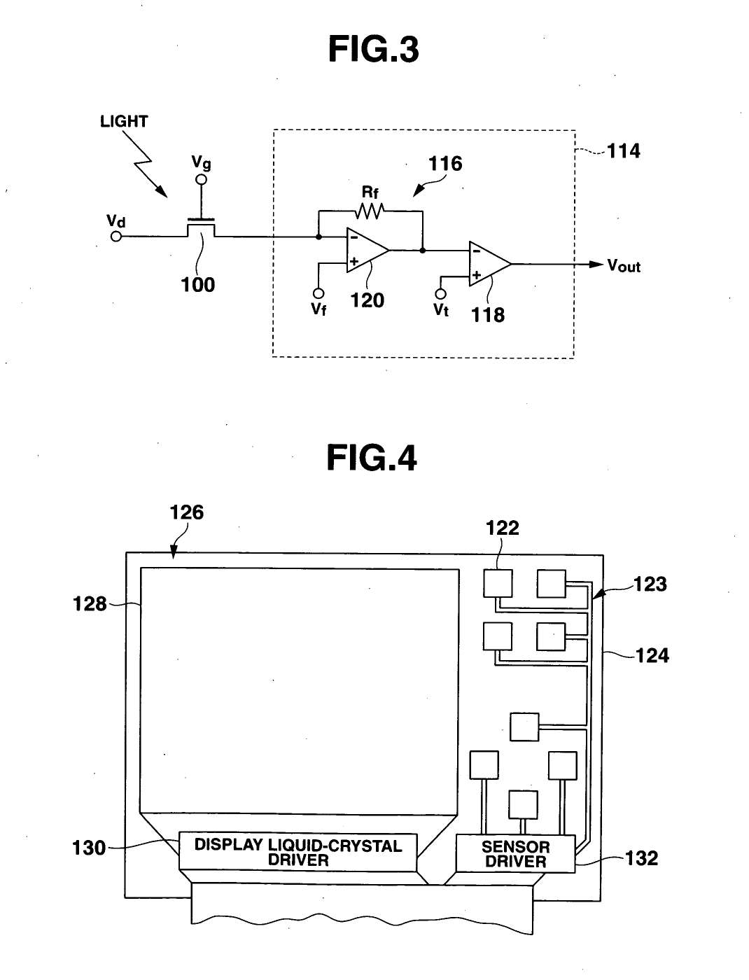

Whether the outputs of the sensor TFTs 100-1 and 100-2 are coincident or not can be determined by discriminating means that includes, for example, such a detection circuit 114 as illustrated in FIG. 3.

As FIG. 3 shows, the detection circuit 114 comprises a current-to-voltage conversion circuit 116 and a comparator 118. The current-to-voltage conversion circuit 116 is composed of an inverting amplifier 120 and a feedback resistor Rf. The current-to-voltage conversion circuit 116 has its non-inverting input terminal applied with a preset voltage Vf. The feedback resistor Rf is connected between the output terminal and inverting input terminal of the inverting amplifier 120. The inverting input terminal of the inverting amplifier 120 is connected by a line to either the first sensor TFT 100-1 or the second sensor TFT 100-2. The comparator 118 compares the voltage generated by the current-to-voltage conversion circuit 116 with a preset threshold voltage Vt, generating an output signal Vout that indicates whether sensor TFT100 is in the photoelectric conversion state or the photoelectric non-conversion state.

The above-mentioned discriminating means has two detection circuits 114 (not shown) of the type shown in FIG. 3, provided for the sensor TFTs 100-1 and 100-2, respectively, and a logic circuit (not shown) that performs a logic operation on the output signals Vout of the two detection circuits 114. The discriminating means can therefore detects a photoelectric non-conversion state when the output signals of the sensor TFTs 100-1 and 100-2 are “1” and “0,” respectively.

More specifically, the detection circuits connected to the first and second sensor TFTs 100-1 and 100-2, respectively, are connected to a discrimination circuit that includes a non-coincidence circuit. Thus, if the output signal of the discrimination circuit is “1,” the photoelectric outputs are in a non-coincidence state, indicating that the finger 26 rests on the upper polarizing plate 110. If the output signal of the discrimination circuit is “0,” the photoelectric outputs are in a coincidence state, indicating that the finger 26 does not rest on the upper polarizing plate 110.

The operating principle specified above can provide a mechanism that recognizes non-coincidence state (i.e., object-presence state) in the case where the finger 26 touches the photoelectric transducer, and recognizes coincidence stat (i.e., object-absence state) in any other case.

In the present embodiment, the first liquid crystal 102-1 orientated to rotate the light beam passing through it and the second liquid crystal 102-2 orientated not to rotate the light beam passing through it are arranged, constituting a liquid-crystal array.

In front of the liquid-crystal array, the upper polarizing plate 110 that allows passage of only light beams polarized in a specific direction.

The lower polarizing plate 108 linearly polarizes in a specific direction the light 24 emitted from the backlight 22. Light beams polarized in the same way can therefore be applied into the liquid-crystal array from the back thereof. Hence, the backlight 22 and the lower polarizing plate 108 constitute a light-applying means that applies the light polarized in the specific direction, to the finger 26 (i.e., object) from only one position, either from the first liquid crystal 102-1 or the second liquid crystal 102-2.

The first sensor TFT 100-1 that performs photoelectric conversion of the light coming from the upper polarizing plate 110 through the first liquid crystal 102-1 and the second sensor TFT 100-2 that performs photoelectric conversion of the light coming from the upper polarizing plate 110 through the second liquid crystal 102-2 are arranged adjacent to each other and aligned with the first and second liquid crystals 102-1 and 102-2, respectively, thus constituting a photoelectric transducer element array. In accordance with the output of this photoelectric transducer element array, the discriminating means connected to the detection circuit determines whether an object to detect exists or not. So designed is the photoelectric transducer according to the present embodiment.

Thus, the present embodiment can detect that the finger 26 touches even if the extraneous light is intense, as in the same way as in the where no extraneous light is applied to the photoelectric transducer.

FIG. 4 is a plan view of a display panel that incorporates a plurality of photoelectric transducers of the type described above.

The display panel 124 has a touch-panel region 123 and a display region 128. The touch-panel region 123 comprises touch sensors 122. The display region 128 is connected to a display liquid-crystal driver (display liquid-crystal driving means) 130. The touch sensors 122 of the touch-panel region 123 are connected to a sensor driver 132 that comprises thin-film transistors (switching elements). In the display region 128, pixel TFTs (switching elements) and pixel electrodes connected to these pixel TFTs are arranged in rows and columns. The pixel TFTs are identical in structure to the above-described sensor TFTs 100-1 and 100-2, except that a light shield covers the top of each pixel TFT. Each touch sensor 122 includes at least one pair of sensor TFTs 100-1 and 100-2 and has the structure shown in FIG. 1A. The sensor driver (detecting liquid-crystal controlling means) 132 performs two functions. Its first function is to control the pixel electrodes 106, making the liquid crystals 102-2 and 102-2 aligned with the sensor TFTs 100-1 and 100-2 distribute light as has been described above. Its second function is to operate as discriminating means that includes the detection circuits 114. The pixel TFTS, display liquid-crystal driver 130, sensor TFTs 100-1 and 100-2 and sensor driver 132 may be formed in the same process on a TFT substrate 126 made of glass or plastic. If this is the case, the TFT substrate 10 of the photoelectric transducer corresponds to the TFT substrate 126 of the touch-panel region 123. The common electrode 104, countersubstrate 20, upper polarizing plate 110, lower polarizing plate 108 and backlight 22 are provided for both the display region 128 and the touch-panel region 123.

In the embodiment described above, the display liquid-crystal driver 130 and the sensor driver 132 may be constituted by LSI chips.

In the photoelectric transducer and the display panel having the photoelectric transducer, both according to the first embodiment of this invention, the first sensor TFT 100-1 and the second sensor TFT 100-2, which are used as first and second photoelectric transducer elements, respectively, are arranged adjacent to each other. Further, the upper polarizing plate 110, which allows passage of only light polarized in a specific direction, is arranged in front of the first sensor TFT 100-1 and the second sensor TFT 100-2. The light passing though the upper polarizing plate 110 is rotated by 90 with respect to the first sensor TFT 100-1 and is not rotated with respect to the second sensor TFT 100-2. Therefore, only the first TFT sensor 100-1 performs photoelectric conversion of the light 28 reflected from the finger 26 or the extraneous light polarized in a specific direction, such as illumination light emitted from a penlight. Extraneous light, such as sunlight, undergoes photoelectric conversion in both the first sensor TFT 100-1 and the second sensor TFT 100-2. Hence, the sensor TFTs 100-1 and 100-2 can generate an output that accords with the type of input light. Signal light, such as the reflected light, can therefore be distinguished from the extraneous light, such as sunlight.

The outputs of the sensor TFTs 100-1 and 100-2 are supplied to the discriminating means including the detection circuits 114. From the outputs of the detection circuits 114, it is determined whether an object that should be detected exists on the upper polarizing plate 110.

Therefore, an object is reliably found to exist if only the first sensor TFT 100-1, for example, generates an output. If both the first sensor TFT 100-1 and the second sensor TFT 100-2 generate an output, an object is found not to exist, even if extraneous light is applied to the photoelectric transducer. If neither the first sensor TFT 100-1 nor the second sensor TFT 100-2 generates an output, an object is found not to exist. In other words, no object are found to exist if neither reflected light nor extraneous light is applied to the sensor TFTs 100-1 and 100-2. In this case, too, no errors occur. Thus, the photoelectric transducer produces no errors even if it receives extraneous light 112 (mainly sunlight).

The backlight 22 and the lower polarizing plate 108, which function as illumination means, applies the light polarized by 90° in the direction opposite to the aforementioned polarized light, from the back of the first and second sensor TFTs 100-1 and 100-2. The aforementioned polarized light is therefore applied to the finger 26, exclusively from that part of the upper polarizing plate 110 which faces the first sensor TFT 100-1. Thus, the light 24 emitted from the backlight 22 emerges from only the position that corresponds to the first sensor TFT 100-1. As a result, only the first sensor TFT 100-1 can detect the reflected light 28, i.e., signal light.

Since the first and second sensor TFTs 100-1 and 100-2 alone constitute a light-guiding means, the light traveling through the specific region that lies on the first sensor TFT 100-1 can be rotated easily.

The photoelectric transducer according to this invention has the same structure as the display region 128 of the display panel 124. The photoelectric transducer can therefore share the same TFT substrate with the display panel 124. (This means that the display panel 124 having touch sensor 122 can be produced without the necessity of increasing the number of manufacturing steps.)

If the photoelectric transducer and the display panel 124 share the same TFT substrate, they can share the backlight 22, too.

### Second Embodiment

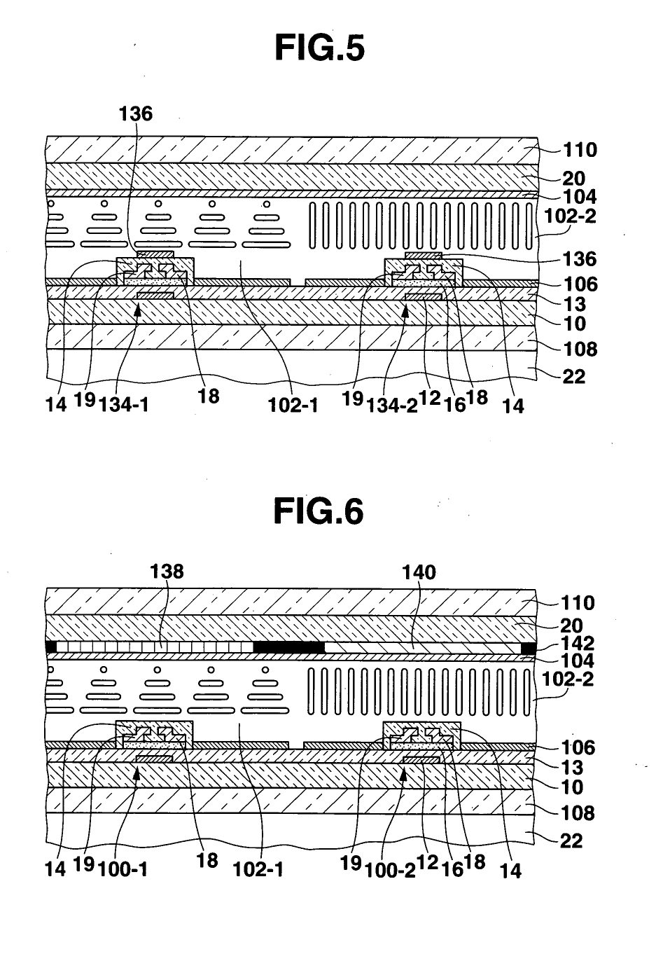

FIG. 5 is a magnified sectional view showing the configuration of a photoelectric transducer according to the second embodiment of this invention. The components of the photoelectric transducer according to this embodiment, which are identical to those of the photoelectric transducer according to the first embodiment, are designated by the same reference numbers and will not be described. For simplicity of illustration, only one pair of photoelectric transducer elements is shown in FIG. 5.

The photoelectric transducer according to the second embodiment differs from the first embodiment in that the photoelectric transducer elements are first and second double-gate (DG) TFT sensors 134-1 and 134-2, each constituted by a double-gate a-Si TFT, not first and second sensor TFTs 100-1 and 100-2 each of which is constituted by an a-Si TFT.

As shown in FIG. 5, the first and second DG TFT sensors 134-1 and 134-2 each comprise a gate electrode 12, transparent insulating films 13 and 14, a photoelectric transducer part 16, a source electrode 18, a drain electrode 19, and a transparent upper gate electrode 136. The gate electrode 12 is formed on a transparent TFT substrate 10. The transparent insulating film 13 is formed on the gate electrodes 12. The photoelectric transducer part 16 is formed on the insulating film 13 and opposed to the gate electrode 12. The source electrode 18 and drain electrode 19 are formed on the photoelectric transducer part 16. The transparent insulating film 14 covers the upper surface and sides of the photoelectric transducer part 16, source electrode 18 and drain electrode 19. The transparent upper gate electrode 136 is provided on the insulating film 14 and aligned with the photoelectric transducer part 16, source electrode 18 and drain electrode 19.

Having DG TFT sensors 134-1 and 134-2 each constituted by a double-gate a-Si TFT, this photoelectric transducer achieves the same advantages as the first embodiment. Further, its sensitivity can be well controlled by operating the two gates at different times, to attain a great bright/dark output ratio.

### Third Embodiment

FIG. 6 is a magnified sectional view showing the configuration of a photoelectric transducer according to the third embodiment of the present invention. The components of the photoelectric transducer according to this embodiment, which are identical to those of the photoelectric transducer according to the first embodiment, are designated by the same reference numbers and will not be described. For simplicity of illustration, only one pair of photoelectric transducer elements is shown in FIG. 6.

The photoelectric transducer according to the third embodiment is characterized by comprising a color filter that allows passage of light having wavelength falling in a specific range and a color filter that shields light having wavelength falling in the specific range, which the color filters are provided on the lower surface (a-Si TFT side) of the transparent countersubstrate 20. More precisely, one color filter is a red filter 138 that allows passage of light in red-wavelength range, and the other color filter is a green filter 140 that shields light in red-wavelength range. The red color filter 138 is formed, facing the first sensor TFT 100-1, and the green filter 140 is formed, facing the second sensor TFT 100-2. Between the red filter 138 and the green filter 140, a black mask 142 is formed. The black mask 142 is made of light-absorbing material such as resin, chromium oxide or the like. The color filters 138 and 140 and the black mask 142 are formed in a semiconductor-manufacturing process.

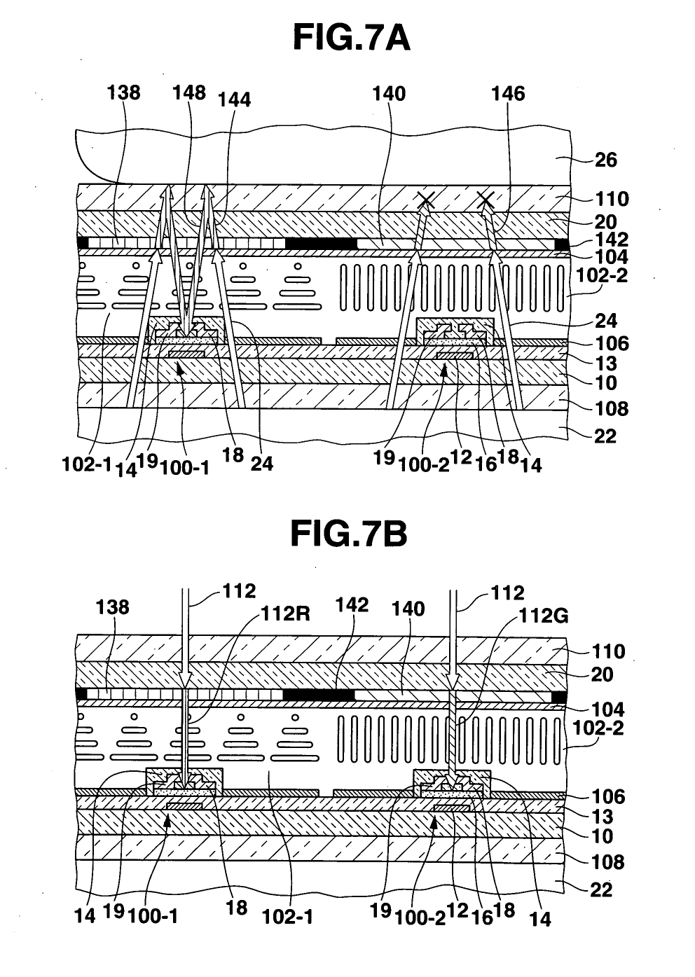

How the photoelectric transducer shown in FIG. 6 operates will be explained with reference to FIGS. 7A and 7B. FIG. 7A is a sectional view explaining how light travels in the photoelectric transducer if a finger 26 rests on the upper polarizing plate 110.

FIG. 7B is a sectional view explaining how intense extraneous light 112, if applied, travels in the photoelectric transducer of FIG. 6.

As shown in FIG. 7A, the light 24 emitted from the backlight 22 is linearly polarized in a specific direction by the lower polarizing plate 108 formed on the lower surface of the TFT substrate 10, as has been explained in conjunction with the first embodiment. The light 24 thus polarized travels through the gap between the adjacent sensor TFTs 100-1 and 100-2, passes through the TFT substrate 10, insulating film 13 and pixel electrodes 106, and is applied to the liquid crystals 102-1 and 102-2 arranged on the sensor TFTs 100-1 and 100-2, respectively.

The light 24 applied to the first liquid crystal 102-1 arranged on the first sensor TFTs 100-1 is rotated through 90° because of the molecular orientation of the first liquid crystal 102-1. The light 24 thus rotated passes through the common electrode 104 and is applied to the red filter 138. The red filter 138 filters those components of the light which fall outside the red-wavelength range, outputting R light 144. R light 144 passes through the countersubstrate 20 and is applied to the upper polarizing plate 110.

On the other hand, the light 24 applied to the second liquid crystal 102-2 arranged on the second sensor TFTs 100-2 is not rotated because of the molecular orientation of the second liquid crystal 102-2. The light not rotated is applied to the green filter 140. The green filter 140 filters those components of the light which fall outside the green-wavelength range, outputting G light 146. G light 146 passes through the countersubstrate 20 passes through the common electrode 104 and countersubstrate 20 and is applied to the upper polarizing plate 110.

As described above, the upper polarizing plate 110 is arranged, with its polarization axis intersecting at right angles with that of the lower polarizing plate 108. Therefore, R light 144 rotated by 90° as it passes through the first liquid crystal 102-1 provided on the first sensor TFT 100-1 can travel through the upper polarizing plate 110. However, the G light 146 having passed through the second liquid crystal 102-2 provided on the second sensor TFT 100-2 and therefore not rotated at all is absorbed by the upper polarizing plate 110. As a result, R light 144 emerges from only that region of the upper polarizing plate 110 which is aligned with the first sensor TFT 100-1.

R light 144 thus emerging is reflected by the finger 26, i.e., object, resting on the upper polarizing plate 110. R light 144 thus reflected, hereinafter called reflected R light 148, enters the photoelectric transducer. Reflected R light 148 travels through the upper polarizing plate 110, red filter 138, countersubstrate 20, common electrode 104, liquid crystal 102-1 and insulating film 14. Reflected R light 148 is eventually applied to the first sensor TFT 100-1.

As long as the finger 26 touches the photoelectric transducer, the first sensor TFT 100-1 performs photoelectric conversion, while the second sensor TFT 100-2 does not perform photoelectric conversion. This state (that is, the sensor TFTs 100-1 and 100-2 remain in a photoelectric conversion state and a non-photoelectric conversion state, respectively) shall be called non-coincidence state of photoelectric-output (i.e., object-presence state).

Assume that as shown in FIG. 7B, the finger 26 does not rest on the upper polarizing plate 110 and extraneous light 112 having higher luminance than the light 24 emitted by the backlight 22, such as sunlight, is applied to the photoelectric transducer. Then, the extraneous light 112 passes through the upper polarizing plate 110, is linearly polarized in a specific direction, travels through the countersubstrate 20 and is applied to the red filter 138 and green filter 140. The red component 112R of the extraneous light 112, emerging from the red filter 138, travels through the common electrode 104, is rotated by 90° by the in the first liquid crystal 102-1 arrange on the first sensor TFT 100-1. The red component 112R thus rotated travels through the insulating film 14 and is applied to the first sensor TFT 100-1. Meanwhile, the green component 112G of the extraneous light 112, emerging from the green filter 140, is not rotated in the second liquid crystal 102-2 arranged on the second sensor TFT 100-2, travels through the insulating film 14 and is applied to the second sensor TFT 100-2. Thus, the first sensor TFT 100-1 performs photoelectric conversion of the red component 112R of the extraneous light 122, and the second sensor TFT 100-2 performs photoelectric conversion of the green component 112G of the extraneous light 122. In this case, the direction of the polarization axis of the upper polarizing plate 110 achieves no effects at all. That is, both sensor TFTs 100-1 and 100-2 perform photoelectric conversion. In the present embodiment, this state is defined as coincidence state of photoelectric-output (i.e., object-absence state).

If the luminance of the extraneous light 112 is low, neither sensor TFT 100-1 nor sensor TFT 100-2 performs photoelectric conversion. This state is defined also as coincidence state of photoelectric-output (i.e., object-absence state) in the present embodiment.

The circuit that determines which state, non-coincidence or coincidence, the output of the photoelectric transducer indicates has the same configuration as described in connection with the first embodiment.

The operating principle specified above provides a mechanism that recognizes non-coincidence state (i.e., object-presence state) in the case where the finger 26 touches the photoelectric transducer, and recognizes coincidence stat (i.e., object-absence state) in any other case.

In the third embodiment, the color filters 138 and 140, which are not provided in the first embodiment, prevent the reflected R light (i.e., R light 144 reflected by the finger 26) to be detected by the first sensor TFT 100-1 from leaking via the countersubstrate 20 into the second sensor TFT 100-2 arranged adjacent to the first sensor TFT 100-1.

In an actual photoelectric transducer according to the third embodiment, the liquid crystals 102-1 and 102-2 have a width of about a few microns (μm), but the countersubstrate 20 is very thick (e.g., about 1 mm at most). Inevitably, the countersubstrate 20 is the main light-leakage path. In the third embodiment, reflected R light 148 (i.e., the red component of the light detected by the first sensor TFT 100-1, emerging from the red filter 138 and reflected by the upper polarizing plate 110) is absorbed by the green filter 140 even if it leaks through the countersubstrate 20. Hence, reflected R light 148 never reaches the second sensor TFT 100-2 that is arranged below the green color filter 140.

Since reflected R light 148 never reaches the second sensor TFT 100-2 if it should leak through the countersubstrate 20, the first and second sensor TFTs 100-1 and 100-2 can be arranged, close to each other.

### Fourth Embodiment

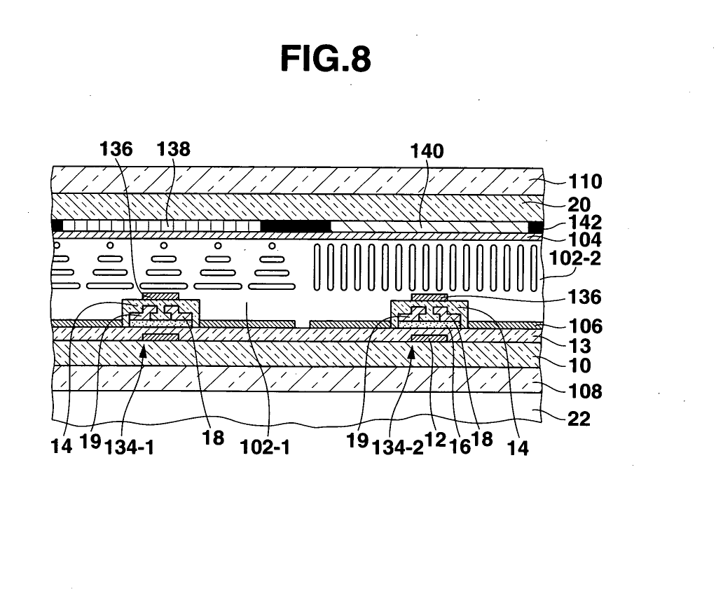

FIG. 8 is a magnified sectional view showing the configuration of a photoelectric transducer according to the forth embodiment of the present invention. The components of the photoelectric transducer according to this embodiment, which are identical to those of the photoelectric transducer according to the third embodiment, are designated by the same reference numbers and will not be described. For simplicity of illustration, only one pair of photoelectric transducer elements is shown in FIG. 8.

The photoelectric transducer according to the fourth embodiment differs from the third embodiment in that the photoelectric transducer elements are first and second DG TFT sensors 134-1 and 134-2, each constituted by a double-gate a-Si TFT, not first and second sensor TFTs 100-1 and 100-2 each of which is constituted by an a-Si TFT.

Having DG TFT sensors 134-1 and 134-2 each constituted by a double-gate a-Si TFT, this photoelectric transducer achieves the same advantages as the third embodiment. Further, its sensitivity can be well controlled by operating the two gates at different times, to attain a great bright/dark output ratio.

### Fifth Embodiment

The fifth embodiment of this invention is a display panel that incorporates a photoelectric transducer according to the third embodiment. In the display panel, color filters 138 and 140 are used as explained in conjunction with the third embodiment. Therefore, the first sensor TFT 100-1 and the second sensor TFT 100-2 can be arranged close to each other. Hence, in the display panel, the display region and the touch-panel region can be integrally formed.

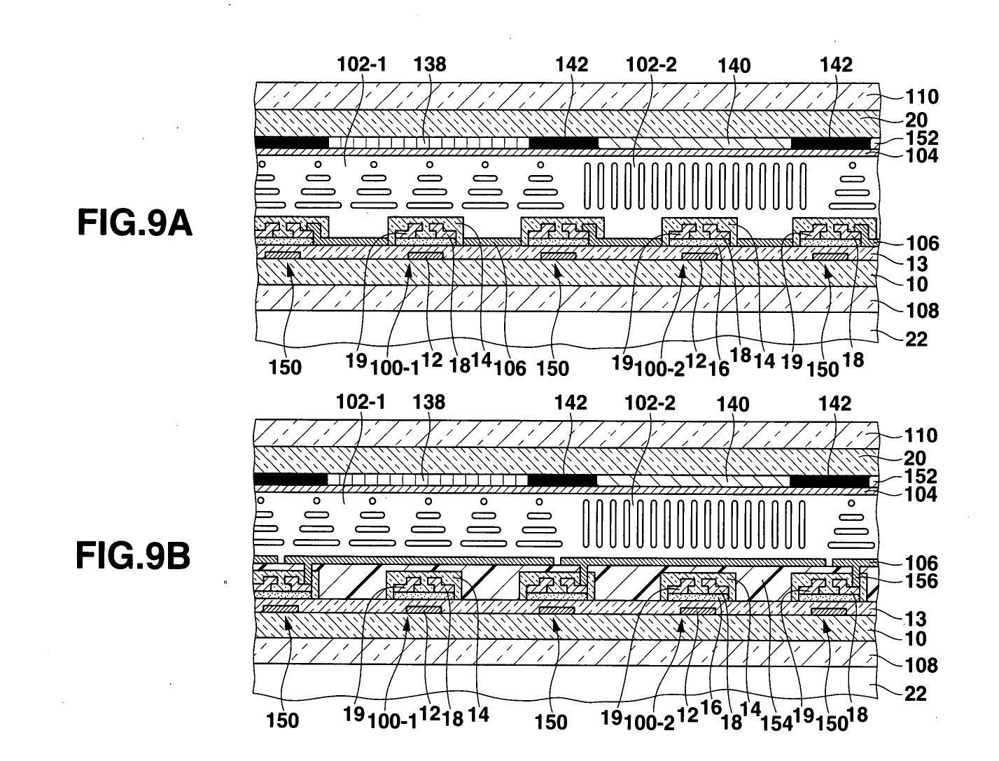

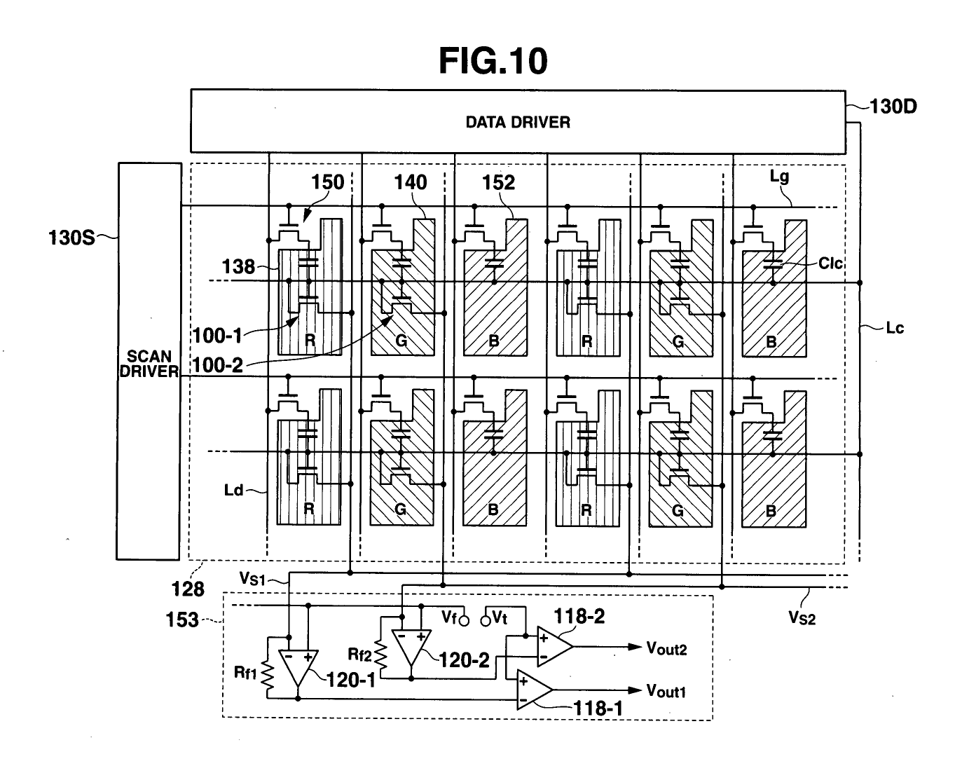

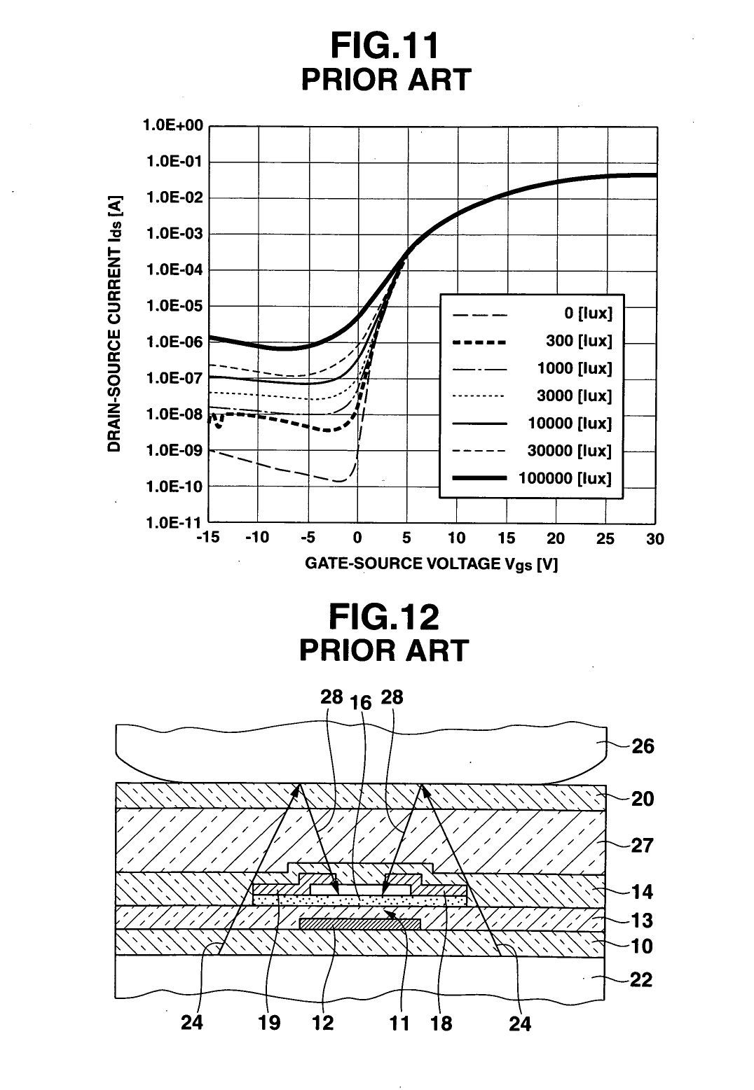

FIG. 9A is a magnified sectional view of this display panel. For simplicity of illustration, only two of photoelectric transducer elements are shown, which constitute one of the touch sensors provided in the touch-panel region. FIG. 10 is a diagram showing the circuit configuration including the one touch sensor. The components identical to those of the first to fourth embodiments are designated by the same reference numbers in FIG. 9A and FIG. 10 and will not be described in detail.

As shown in FIG. 10, the display panel has liquid-crystal capacitors Clc, pixel TFTs (switching elements) 150, scanning lines Lg, and signal lines Ld. Each liquid-crystal capacitor Clc is composed of liquid crystals 102-1 and 102-2 filled between a pixel electrode 106 and a common electrode 104. Each pixel TFT 150 has its source connected to one pixel electrode 106. The scanning lines Lg extend parallel to one another, in the row direction of a matrix, and are connected to the gates of the pixel TFTs 150, respectively. The signal lines Ld extend parallel to one another, in the column direction of the matrix, and are connected to the drain electrodes 19 of the pixel TFTs 150, respectively. The display panel further comprises a scan driver 130S and a data driver 130D, both included in the above-mentioned display liquid-crystal driver 130. The scan driver 130S selects pixel TFTs 150. The data driver 130D applies signal voltage to the pixel TFT 150 selected by the scan driver 130S, controlling the molecular orientations of the liquid crystals 102-1 and 102-2. The liquid crystals 102-1 and 102-2 therefore display image data. Each liquid-crystal capacitor Clc and the pixel TFT 150 connected the capacitor Clc constitute a liquid-crystal pixel (display pixel). For each display pixel, a red filter 138, a green filter 140 or a blue filter 152 is provided. Hence, the display panel can display a color image.

In the present embodiment, first and second sensor TFTs 100-1 and 100-2 of the type used in the third embodiment are incorporated in a display pixel having a red filter 138 and a display pixel having a green filter 140, respectively.

More specifically, as shown in FIG. 9A, a pixel TFT 150 and sensor TFTs 100-1 and 100-2 are formed on a transparent TFT substrate 10, in the same manufacturing step. Further, a blue filer 152 is formed on the common electrode 104, in addition to the red filter 138 and the green filter 140.

As shown in FIG. 10, the gate and drain electrodes 12 and 19 of sensor TFT 100-1 and the gate and drain electrodes 12 and 19 of sensor TFT 100-2 are connected to a common line Lc that is set at the same potential as the common electrode 104. On the other hand, the source electrode 18 any first sensor TFT 100-1 is connected to a source line Vs1, and the source electrode 18 of any second sensor TFT 100-2 is connected to a source line Vs2.

The source liens Vs1 and Vs2 are connected to a detection circuit 153. The detection circuit 153 may be incorporated in discriminating means that is provided in the display liquid-crystal driver 130. The detection circuit 153 may otherwise be provided as sensor driver 132 that includes such discriminating means. The detection circuit 153 includes two detection circuits of the type shown in FIG. 3 and described in connection with the first embodiment. The discriminating means includes a discriminating circuit (not shown) having a logic circuit that performs a logic operation on the output signals Vout1 and Vout2 of the two detection circuits provided in the detection circuit 153. The detection circuit for the first sensor TFTs 100-1 connected in parallel comprises a comparator 118-1 and a current-to-voltage conversion circuit composed of an inverting amplifier 120-1 and a feedback resistor Rf1. Similarly, the detection circuit for the second sensor TFTs 100-2 connected in parallel comprises a comparator 118-2 and a current-to-voltage conversion circuit composed of an inverting amplifier 120-2 and a feedback resistor Rf2.

When the display panel, in which a liquid crystal display panel and a touch panel are formed integral, is used to display an image, the result obtained by the discrimination means having the detection circuit 153 is neglected. This is because the light distributions achieved by the first and second liquid crystals 102-1 and 102-2 arranged on the first and second sensor TFTs 100-1 and 100-2, respectively, depend on the image data to display, not related to an object placed on the display panel, such as a finger.

When the display panel is used as a touch panel, the light distributions achieved by the liquid crystals are controlled in order to detect an object such as a finger resting on the touch panel. More specifically, the data driver 130D applies signal voltages to the pixel TFTs 150 so that the pixel corresponding to the red filter 138 may appear bright and the pixel corresponding to the green filter 140 may appears dark. Note that the pixel corresponding to the blue filter 152 of any pixel TFT 150 may appear either bright or dark when driven.

In this detection circuit 153, too, the first comparator 118-1 compares the output voltage of the first current-to-voltage conversion circuit composed of the inverting amplifier 120-1 and feedback resistor Rf1 with a preset threshold voltage Vt, thus outputting a signal Vout1 that indicates whether the first sensor TFT 100-1 is performing photoelectric conversion or not. Similarly, the second comparator 118-2 compares the output voltage of the second current-to-voltage conversion circuit composed of the inverting amplifier 120-2 and feedback resistor Rf2 with the preset threshold voltage Vt, thus outputting a signal Vout2 that indicates whether the second sensor TFT 100-2 is performing photoelectric conversion or not. Hence, whether a finger 26 rests on the display panel can be determined in the same way as has been explained with reference to FIG. 3. In the detection circuit 153, however, the output voltages of the inverting amplifiers 120-1 and 120-2 correspond to the sum of currents flowing in all first sensor TFTs 100-1 and the sum of currents flowing in all second sensor TFTs 100-2, respectively, because the source electrodes of all first sensor TFTs 100-1 are connected by one source line Vs1 to the inverting amplifier 120-1 and the source electrodes of all second sensor TFTs 100-2 are connected by one source line Vs2 to the inverting amplifier 120-2. The output voltages of the inverting amplifiers 120-1 and 120-2 therefore greatly differ from each other. This makes it easier to determine whether a finger 26 rests on the display panel. Moreover, this helps to determine accurately whether a finger 26 rests on the panel, despite that the sensor TFTs 100-1 and 100-2 are different in photoelectric conversion state and element characteristics.

The display panel according to the fifth embodiment is identical in configuration to the ordinary liquid crystal display panel, except for the use of the detection circuit 153. Therefore, it can be formed integral with a touch panel, scarcely increasing the number of manufacturing steps.

In this display panel, the sensor TFTs 100-1 and 100-2 and the circuits for driving them are protected below the countersubstrate 20. The display panel is therefore superior to the conventional touch panel, which is formed by applying a resinous sheet sensor on the surface of LCD, in terms of durability such as abrasion resistance.

In the present embodiment, the first and second sensor TFTs 100-1 and 100-2 used as photoelectric transducer elements, each constituted by an a-Si TFT, may be replaced by first and second DG TFT sensors 134-1 and 134-2 of the type used in the second and fourth embodiments, each constituted by a double-gate a-Si TFT.

In the fifth embodiment, one touch sensor is arranged in the touch-panel region almost as large as the display region. Instead, a plurality of touch sensors may be arranged in the touch-panel region. In this case, too, it suffices to connect sensor TFTs 100-1 to the inverting amplifier 120-1 or sensor TFTs 100-2 to the inverting amplifier 102-2.

Furthermore, the sensor TFTs 100-1 and 100-2 and the pixel TFTs 150 need not have the same structure.

### Sixth Embodiment

FIG. 9B is a magnified sectional view of a display panel according to a sixth embodiment of the invention, in which the display region and the touch-panel region are integrally formed. For simplicity of illustration, only two of photoelectric transducer elements are shown in FIG. 9B. The components identical to those of the fifth embodiment are designated by the same reference numbers in FIG. 9B and will not be described in detail.

In the sixth embodiment, a planarizing film 154 made of transparent resin covers the sensor TFTs 100-1 and 100-2 and pixel TFTs 150, all formed on the TFT substrate 10, thereby providing a structure having a flat upper surface. On this structure, transparent pixel electrodes 106 are formed. Contact holes 156 are made in the planarizing film 154 and insulating film 14. Thus, the source electrode 18 and drain electrode 19 of each pixel TFT 150 are connected to one pixel electrode 106.

The planarizing film 154 so formed reduces the disturbance of light distributions achieved by the liquid crystals 102-1 and 102-2. This improves the sensor characteristics and enhances the quality of any image displayed.

The present invention has been described, with reference to several embodiments. This invention is not limited to the embodiments, nevertheless. Various changes and modifications can, of course, be made within the scope and spirit of the present invention.

In the third to sixth embodiments, the sensor TFTs 100-1 and 100-2 are positioned below the red filter 138 and the green filter 140, respectively. Instead, they may be arranged below any other types of color filters. In order to prevent leakage of the reflected light, however, the sensor TFTs 100-1 and 100-2 must be positioned below two filters of different colors, respectively.

In the third to sixth embodiments, the color filters are arranged on the lower surface of the countersubstrate 20. The color filters may be arranged on the TFT substrate 10, instead.

In the fifth and sixth embodiments, the pixels are arranged in the display region 128 in a stripe pattern. Nonetheless, the pixels may be arranged in any other pattern, such as delta pattern.

In the second and fourth embodiments, the sensor TFTs 100-1 and 100-2 used as photoelectric transducer elements are each constituted by a double-gate a-Si TFT. Instead, they may be multi-gate a-Si TFTs, each having more gate electrodes than the double-gate a-Si TFT.

In the first to sixth embodiments, the photoelectric transducer elements are a-Si TFTs. The photoelectric transducer elements may be of any other type, such as polysilicon TFTs. Further, they are not limited to transistors (e.g., TFTs). For example, photoelectric transducer elements of any other type, such as photodiodes.

The first to sixth embodiments use TN liquid crystal. Nonetheless, liquid crystal of vertically aligned (VA) type may be used instead. Alternatively, any other type of liquid crystal may be used, such as horizontally aligned (HA or IPS) type using homogeneous liquid crystal. If liquid crystal of horizontally aligned type is used, the common electrode 104 should be provided near the TFT substrate 10, not close to the countersubstrate 20.

The photoelectric transducers according to the first to sixth embodiments have photoelectric transducer elements of two types (i.e., first sensor TFT or fist DG TFT sensor, and second sensor TFT or second DG TFT sensor). Nevertheless, the present invention can provide a photoelectric transducer that has photoelectric transducer elements of tree or more types.

Furthermore, the detection circuits 114 are not limited to the one having the configuration shown in FIG. 3.

In the embodiments described above, the lower polarizing plate 108 and the upper polarizing plate 110 are arranged with their polarization axes (transmission axes) intersecting at right angles. Their polarization axes may be aligned with each other, nevertheless. In this case, the photoelectric-output is considered to stay in non-coincidence (i.e., object-presence state) if the second photoelectric transducer element performs photoelectric conversion and the first photoelectric transducer element does not perform photoelectric conversion.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A photoelectric transducer comprising:
a photoelectric transducer element array which is composed of a plurality of photoelectric transducer elements including a first photoelectric transducer element and a second photoelectric transducer element;
a lower polarizing plate which is arranged on a lower surface of the photoelectric transducer element array and allows passage of only light polarized in a fist specific polarized direction;
an upper polarizing plate which is arranged above an upper surface of the photoelectric transducer element array and allows passage of only light polarized in a second specific polarized direction different from the fist specific polarized direction; and
liquid crystals which are arranged between the photoelectric transducer element array and the upper polarizing plate and which guide the light that has passed through the lower polarizing plate, respectively through the upper polarizing plate in a transmitted state and not through upper polarizing plate in a non-transmitted state,
wherein the light that has passed through the upper polarizing plate is reflected by an object resting on the upper polarizing plate, it is thereby determined whether an object exists.

2. The photoelectric transducer according to claim 1, further comprising a backlight provided below the lower polarizing plate.

3. The photoelectric transducer according to claim 1, further comprising a discriminating circuit including a plurality of detection circuits which detect an output of the first photoelectric transducer element and an output of the second photoelectric transducer element.

4. The photoelectric transducer according to claim 3, wherein the photoelectric transducer elements include a plurality of first photoelectric transducer elements and a plurality of second photoelectric transducer elements, and
each of the detection circuits has an input terminal which receives the outputs of the plurality of first photoelectric transducer elements or the outputs of the plurality of second photoelectric transducer elements.

5. The photoelectric transducer according to claim 3, wherein whether an object exists is determined from the output of the first photoelectric transducer element and the output of the second photoelectric transducer element.

6. The photoelectric transducer according to claim 5, wherein when the outputs of the first photoelectric transducer element and second photoelectric transducer element are different, it is determined that an object exists.

7. The photoelectric transducer according to claim 1, further comprising a first pixel electrode provided in association with the first photoelectric transducer element, a second pixel electrode provided in association with the second photoelectric transducer element, and a common electrode opposed to the first and second pixel electrodes.

8. The photoelectric transducer according to claim 1, further comprising:
a first filter which is arranged between the upper polarizing plate and the liquid crystal aligned with the first photoelectric transducer element and which allows passage of light having wavelength falling in a first specific range;
a second filter which is arranged between the upper polarizing plate and the liquid crystal aligned with the second photoelectric transducer element and which allows passage of light having wavelength falling in a second specific range different from the first specific range.

9. The photoelectric transducer according to claim 1, wherein the first photoelectric transducer element and the second photoelectric transducer element are each constituted by an amorphous silicon thin-film transistor.

10. The photoelectric transducer according to claim 1, wherein the first photoelectric transducer element and the second photoelectric transducer element are each constituted by a double-gate, amorphous silicon thin-film transistor.

11. The photoelectric transducer according to claim 1, wherein the liquid crystals are of TN type and guide light through the upper polarizing plate in a transmitted state or not through upper polarizing plate in a non-transmitted state, when a twist angle is changed.

12. The photoelectric transducer according to claim 1, wherein the liquid crystals are of horizontally aligned type and, when rotated in a horizontal plane, guide light through the upper polarizing plate in a transmitted state or not through upper polarizing plate in a non-transmitted state.

13. The photoelectric transducer according to claim 1, wherein the liquid crystals are of vertically aligned type and, when rotated in a vertical plane, guide light through the upper polarizing plate in a transmitted state or not through upper polarizing plate in a non-transmitted state.

14. A photoelectric transducer comprising:
a photoelectric transducer element array which is composed of a plurality of photoelectric transducer elements including a first photoelectric transducer element and a second photoelectric transducer element;
a lower polarizing plate which is arranged on a lower surface of the photoelectric transducer element array and allows passage of only light polarized in a first specific polarized direction;
an upper polarizing plate which is arranged above an upper surface of the photoelectric transducer element array and allows passage of only light specific polarized in a second specific polarized direction different from the fist specific polarized direction;
first liquid crystal arranged between the upper polarizing plate and a region in which the first photoelectric transducer element lies;
second liquid crystal arranged between the upper polarizing plate and a region in which the second photoelectric transducer element lies;
a display liquid-crystal driving circuit which drives the first liquid crystal, causing the same to guide the light that has passed the lower polarizing plate, through the upper polarizing plate in a transmitted state, and which drives the second liquid crystal, causing the same to guide the light that has passed the lower polarizing plate, not through upper polarizing plate in a non-transmitted state; and
a discriminating circuit including a plurality of detection circuits which detect an output of the first photoelectric transducer element and an output of the second photoelectric transducer element,
wherein whether an object exists on the upper polarizing plate is determined from an output of the first photoelectric transducer element and an output of the second photoelectric transducer element.

15. The photoelectric transducer according to claim 14, wherein the photoelectric transducer elements includes a plurality of first photoelectric transducer elements and a plurality of second photoelectric transducer elements, and
each of the detection circuits has an input terminal which receives the outputs of the plurality of first photoelectric transducer elements or the outputs of the plurality of second photoelectric transducer elements.

16. A display panel having a display region and a touch-sensor region and comprising:
a TFT substrate including pixel electrodes provided within the display region and within the touch-sensor region;
a backlight which is provided at the back of the TFT substrate;
a countersubstrate which is arranged at a surface of the TFT substrate and spaced apart therefrom;
liquid crystals which are provided between the TFT substrate and the countersubstrate;
a lower polarizing plate which is arranged on a lower surface of the TFT substrate and which allows passage of only light polarized in a first specific polarized direction;
an upper polarizing plate which is arranged on an upper surface of the countersubstrate and which allows passage of only light polarized in a second specific polarized direction different from the fist specific polarized direction;
switching elements which are connected to the pixel electrodes provided within the display region of the TFT substrate;
a first photoelectric transducer element and a second photoelectric transducer element which are connected to the pixel electrodes provided within the touch-sensor region of the TFT substrate;
detecting liquid-crystal controlling means which controls the liquid crystal associated with the first photoelectric transducer element, causing the same to guide the light that has passed the lower polarizing plate, through the upper polarizing plate in a transmitted state, and which controls the liquid crystal associated with the second photoelectric transducer element, causing the same to guide the light that has passed the lower polarizing plate, not through the upper polarizing plate in a non-transmitted state; and
display liquid-crystal driving means which drives the switching elements provided in the display region, causing the display region to display an image.

17. The display panel according to claim 16, further comprising a discriminating circuit including a plurality of detection circuits which detect an output of the first photoelectric transducer element and an output of the second photoelectric transducer element.

18. The display panel according to claim 16, further comprising other first photoelectric transducer element and other second photoelectric transducer element, and
wherein each of the detection circuits has an input terminal which receives the outputs of the first photoelectric transducer elements or the outputs of the second photoelectric transducer elements.

19. The display panel according to claim 17, wherein the discriminating circuit determines whether an object exists on the upper polarizing plate, on the basis of the outputs of the first photoelectric transducer element and the second photoelectric transducer element.

20. The display panel according to claim 19, wherein the discriminating circuit determines that an object exists on the upper polarizing plate, when the outputs of the first photoelectric transducer element and the second photoelectric transducer element do not coincide with each other.

21. A display panel comprising:
a TFT substrate which has a plurality of pixel electrodes and a plurality of switching element which are connected to the pixel electrodes;
a counterelectrode which is arranged, facing the TFT substrate;
liquid crystals which are arranged between the TFT substrate and the counterelectrode;
a lower polarizing plate which is arranged on a lower surface of the TFT substrate and which allows passage of only light polarized in a first specific polarized direction;
an upper polarizing plate which is arranged above an upper surface of the TFT substrate and which allows passage of only light polarized in a second specific polarized direction different from the fist specific polarized direction;
a first photoelectric transducer element which is formed on the TFT substrate and aligned with at least any one of the pixel electrodes;
a second photoelectric transducer element which is formed on the TFT substrate and aligned with at least any other one of the pixel electrodes;
detecting liquid-crystal controlling means which controls the liquid crystal associated with the first photoelectric transducer element, causing the same to guide the light that has passed the lower polarizing plate, through the upper polarizing plate in a transmitted state, and which controls the liquid crystal associated with the second photoelectric transducer element, causing the same to guide the light that has passed the lower polarizing plate, not through the upper polarizing plate in a non-transmitted state; and
display liquid-crystal driving means which drives the switching elements, causing the display region to display an image.

22. The display panel according to claim 21, further comprising a backlight which is provided below the lower polarizing plate.

23. The display panel according to claim 21, further comprising a discriminating circuit including a plurality of detection circuits which detect an output of the first photoelectric transducer element and an output of the second photoelectric transducer element.

24. The display panel according to claim 21, further comprising other first photoelectric transducer element and other second photoelectric transducer element, and
wherein each of the detection circuits has an input terminal which receives the outputs of the first photoelectric transducer elements or the outputs of the second photoelectric transducer elements.

25. The display panel according to claim 23, wherein the discriminating circuit determines whether an object exists on the upper polarizing plate, on the basis of the outputs of the first photoelectric transducer element and the second photoelectric transducer element.

26. The display panel according to claim 23, wherein the discriminating circuit determines that an object exists on the upper polarizing plate, when the outputs of the first photoelectric transducer element and the second photoelectric transducer element do not coincide with each other.
